(19) United States
(12) Patent Application Publication
(10) Pub. No.: US 2006/0073850 A1
(43) Pub. Date: Apr. 6, 2006

(54) Steering a smart antenna using link layer performance

(75) Inventors: Inhyok Cha, Melbourne, FL (US); Ross L. Lintelman, Indialantic, FL (US); Yingxue Li, Melbourne, FL (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/024,290

(22) Filed: Dec. 28, 2004

Related U.S. Application Data
(60) Provisional application No. 60/608,777, filed on Sep. 10, 2004.

(51) Int. Cl. H04M 1/00

(52) U.S. Cl. 455/562.1

(57) ABSTRACT

A method for steering a smart antenna in a wireless communication system begins by selecting a beam steering criterion. The antenna is switched to one of a plurality of measurement positions and link quality metrics are measured at each measurement position. The steering criterion are optimized based on the measured metrics, and the antenna is steered to the position providing the optimized metrics.

### CROSS REFERENCE TO RELATED APPLICATION

This application claims the benefit of U.S. Provisional Application No. 60/608,777, filed Sep. 10, 2004, which is incorporated by reference as if fully set forth herein.

### FIELD OF INVENTION

The present invention generally relates to wireless communications and, more particularly, to steering a smart antenna taking into account link layer performance in a wireless communication system.

### BACKGROUND

Smart antenna technology refers to art where the antenna of a radio communication system has the capability to “smartly” change its radio beam transmission and reception patterns to suit the radio communication environment within which the system operates. An example of such a wireless data communication system is a wireless local area network (WLAN), as shown in FIG. 1. One embodiment of a WLAN is an independent basic service set (IBSS) 100, which includes at least one access point (AP) and at least one station (STA).

For illustration purposes, the IBSS 100 shown in FIG. 1 has one AP 102 and two STAs 104, 106. The AP 102 provides coordination of communications between the STAs 104,106 and with entities outside the WLAN. The STA 104 is equipped with an omni-directional antenna, and its broadcast pattern is shown by a dashed circle. The STA 106 is equipped with a smart antenna and a steering algorithm that enables the antenna to electronically switch to a particular directional pattern (shown by the dashed oval) that enables the STA 106 to communicate with the AP 102 at the highest possible performance.

Methods to steer smart antennas traditionally have relied on measuring raw signal strength at the physical layer. Typically, a smart antenna has multiple directional antenna modes, either beam-formed or beam-selected. From each of the antennas, a measurement of the physical layer signal strength is obtained. These measurements can include the received signal strength indicator (RSSI) measured either in analog form at the receiver antenna connector or in baseband digital form at the baseband section of the receiver, or the received signal-to-noise ratio (SNR) measured at the receiver's baseband processor. The measurements are then averaged and compared against each other to select the best antenna direction for the switched-beam smart antenna.

One of the main issues with steering methods based on physical layer signal strengths is that it is difficult to measure physical layer signal quality indicators accurately, particularly if the quality indicator is the SNR or signal to interference ratio (SIR). This issue exists because it is difficult at the receiver to know whether the currently received signal comprises an undistorted signal plus random noise, if the received signal itself is distorted, or if directional interference is also present in the received signal. Thus, many practical receiver systems use the raw RSSI, which is the measure of aggregate power of the received signals, as the physical layer signal quality indicator.

The first problem with using RSSI is that optimizing the receiver's performance in terms of criteria such as receiver throughput (measured in bits per second), may not be best achieved by selecting the smart antenna direction based on a measurement of physical layer signal strength. There is typically an imperfect correlation between the physical layer signal strength and receiver throughput due to imperfections at the receiver's communication signal processing functions.

An example of this imperfect correlation would be a receiver that has limited capability to compensate for multi-path reflections of signals. At the receiver, the signals from the multiple paths might be combined and processed in such a way that the combined received signals may exhibit a large amplitude or power that would result in large RSSI values. At the same time, the large amplitude or power might result in distortion of the signal waveforms, boosting of the noise, or boosting of the interference. Any of these problems would result in overall lower receiver performance as measured in terms of data throughput achieved.

As applied to switched-beam smart antennas, a steering method based on maximizing the RSSI might in some cases adversely maximize the unwanted interference coming from a particular antenna direction. This would result in lowering the performance of the system at the link layer, which typically affects criteria that are more meaningful to the end user of the system than the maximization of the physical layer signal strength. Therefore, when the beam of a smart antenna is selected to maximize only the physical layer signal strength metrics, it is often possible that such a beam selection or steering may result in sub-optimal performance in the link layer or other more user-meaningful senses.

The second problem with using RSSI is that in smart antenna systems, a particular beam direction might indicate high physical layer signal strength just because there is strong interference coming from that direction, such that the receiver cannot distinguish between the interference and the desired signal. In such cases, the larger indication of received signal strength at the physical layer will not be a good criteria upon which to steer the smart antenna beams.

The third problem with using RSSI is that, unlike the link layer metrics which are essentially metrics counted with high accuracy, physical layer measurements such as RSSI or SNR are less accurate and are expensive in terms of implementation.

FIG. 2 illustrates the RSSI problem in a WLAN. A client STA 200 equipped with a smart antenna system needs to communicate over the air with a desired AP (AP_A) 202 which is located in a particular direction from the STA 200 and can be pointed to by a directed antenna beam 204. However, there is an unknown interfering radio signal source (AP_B) 210 in the “incorrect” direction (212) and AP_B 210 emits radio signals that result in a large RSSI measurement if the smart antenna's beam points toward the incorrect direction (212). If, as in traditional smart antenna algorithms, the antenna beam is selected or formed toward the wrong direction (212) simply because it results in the largest RSSI measurement at STA 200, the STA 200 will not be able to optimally communicate with the desired AP_A 202. In order to achieve the latter objective, the steering algorithm needs to steer the smart antenna's beam direction to the desired direction (204).

### SUMMARY

A method for steering a smart antenna in a wireless communication system begins by selecting a beam steering criterion. The antenna is switched to one of a plurality of measurement positions and link quality metrics are measured at each measurement position. The steering criterion are optimized based on the measured metrics, and the antenna is steered to the position providing the optimized metrics.

A method for selecting a beam steering criterion in a smart antenna system includes the steps of measuring performance metrics, comparing the measured performance metrics, and selecting the beam steering criterion based on the results of the comparison.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a diagram of a WLAN showing different antenna pattern types;

FIG. 2 is a diagram of a WLAN showing the RSSI problem in selecting the best antenna beam;

FIG. 3 is a flowchart of a method for selecting an antenna beam in accordance with the present invention; and

FIG. 4 is a flowchart of a method for selecting steering criterion in accordance with the present invention.

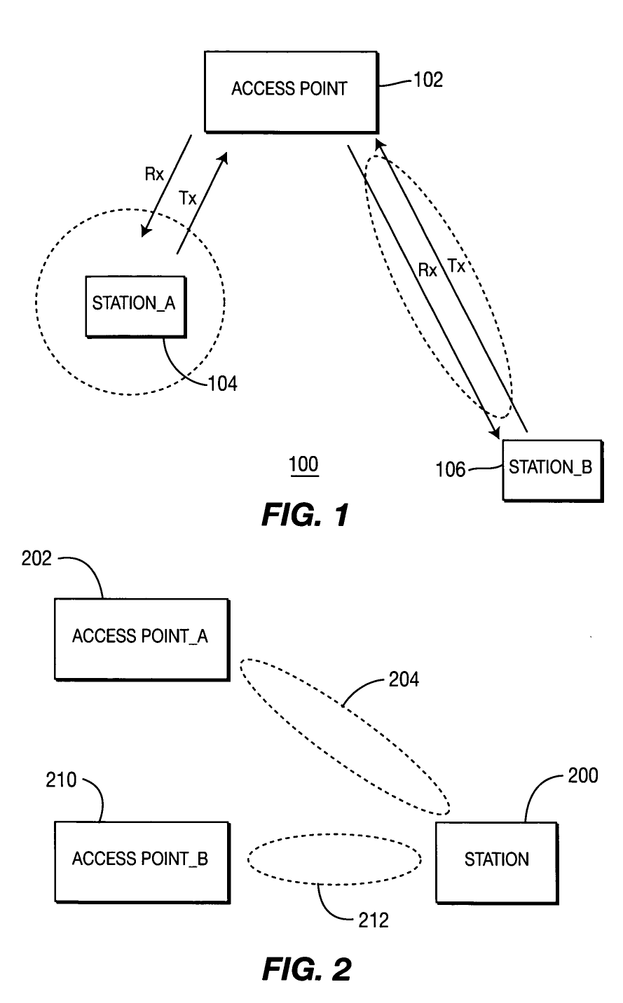

### DETAILED DESCRIPTION OF THE PREFERRED EMBODIMENTS

Hereafter, the term “station” (STA) includes, but is not limited, to a wireless transmit/receive unit, a user equipment, a mobile station, a fixed or mobile subscriber unit, a pager, or any other type of device capable of operating in a wireless environment. When referred to hereafter, the term “access point” (AP) includes, but is not limited to, a base station, a Node B, a site controller, or any other type of interfacing device in a wireless environment.

To illustrate the present invention, the discussion is directed to the “fixed-beam switching” type of smart antenna technology. It is noted that the use of the link layer metrics in steering antenna beams can also be achieved in the “beam-forming” type of smart antenna systems as well. Although the present invention is illustrated by use of an example of a WLAN, the present invention can apply to a wide range of wireless data communication systems where the link layer performance metrics provide meaningful measures of the data communication system's performance. Other examples of such systems include: digital cellular phones, wireless personal digital assistants (PDAs), satellite and terrestrial digital radio transceivers, wireless personal area network (WPAN) devices and systems, and broadband wireless access (BWA) systems.

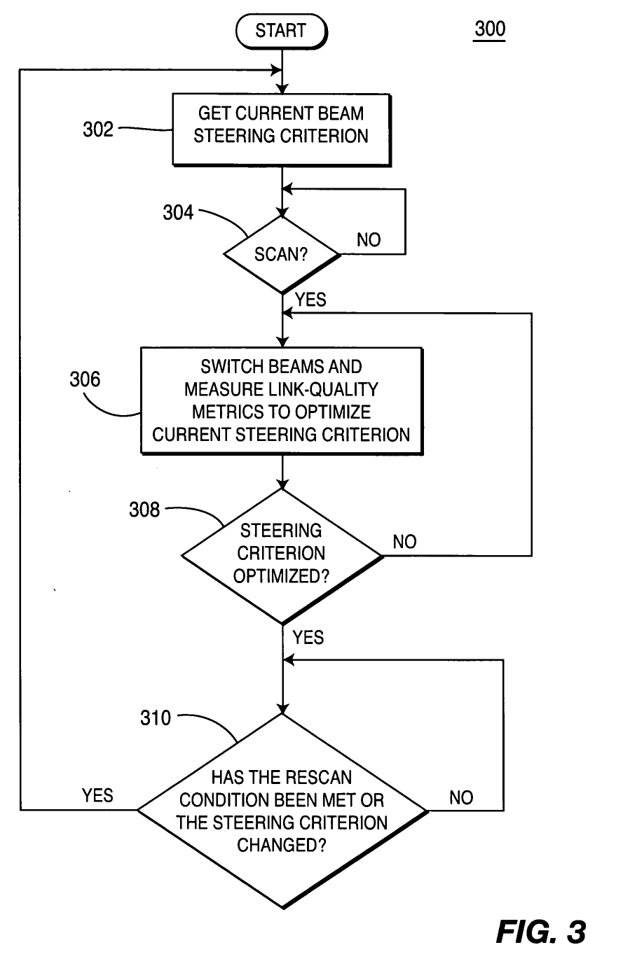

FIG. 3 is a flowchart of a method 300 for steering a smart antenna beam in accordance with the present invention. The method 300 begins by retrieving the current beam steering criterion (step 302). The current beam steering criterion can include the most recently used beam-steering criterion or a default set of values. One example of a steering criterion is a simple average of the upload (transmit-side) and the download (receive-side) data throughput at the link layer. A second example of a steering criterion is a combination of transmit-side throughput and receive-side throughput by two variable, non-negative weighting factors which sum to one. In one implementation, each weighting factor (one for the transmit-side throughput and one for the receive-side throughput) has a value of 0.5.

If a scan condition is met (step 304), then the antenna is switched through a plurality of measurement positions and link-quality metrics are measured at each measurement position in order to optimize the current beam steering criterion (step 306). Each antenna measurement position corresponds to a position from which the antenna can form a beam. An example of a scan condition is a STA having just acquired an AP that it will communicate with (using a pre-selected default antenna mode) and becoming ready to initiate the scan of the multiple switched beams of the smart antenna system. Another example of a scan condition is when a STA is in an idle mode for a certain amount of time without transmitting or receiving data. If the scan condition is not met, the method waits at step 304 until the scan condition is met.

Next, a determination is made whether the steering criterion have been optimized (step 308). One method of optimizing the steering criterion is to differently weight the decision metrics from the receive-side throughput and the transmit-side throughput according to the traffic volume and traffic type from both sides, along with other information related to the STA's configuration. If the smart antenna algorithm residing on the STA is aware, after inspecting the configuration information, that the AP it communicates with employs different antenna diversity schemes for transmission and reception, the algorithm may optimize its antenna selection criterion by only considering the receive-side throughput if there is also heavier traffic on the receive side.

The optimization to be performed depends upon the performance characteristic of the system that the user desires to emphasize. As described above, that optimization is focused on maximizing the receive-side throughput of the STA. Different criteria will be evaluated as the performance characteristic to emphasize changes. Another method of optimizing the steering criterion is to minimize the time required to transmit a certain amount of data. In this method, the STA estimates the time required to transmit a certain amount of data using parameters such as physical layer data rate (PHY_RATE), packet error probability (PE), and information of wireless medium activity (denoted as η). The time is then estimated according to the equation:
Time=Exp(PE×η)/PHY_{—}RATE Equation (1)

If the steering criterion have not been optimized, then the antenna is switched through the plurality of measurement positions and the link-quality metrics are again measured at each measurement position (step 306). If the steering criterion have been optimized (step 308), then a determination is made whether a rescan condition has been met or whether the steering criterion have changed (step 310).

One example of a rescan condition is an event where the measured RSSI of signals received using the currently selected smart antenna beam mode would significantly change in value over a short period of time due to, for example, movement of the STA. Another example of a rescan condition is an event where the measured short term average throughput using the currently selected smart antenna beam mode would significantly change in value over a short period of time due to, for example, movement of the STA.

The steering criterion can be adaptively changed by evaluating the measurements of the link layer metrics. One method to adaptively change the steering criterion is to have the algorithm periodically inspect the volume and type of traffic that it either receives or transmits. The algorithm could select the receive-side throughput, the transmit-side throughput, or a combination of both. One alternative would be for the algorithm to continuously inspect the traffic, instead of periodically.

Unlike traditional smart antenna steering methods which rely on physical layer signal quality indicators such as RSSI or SNR, the method 300 measures link layer performance metrics in appropriately selected measurement intervals. The method 300 then collects and processes the link layer metrics and steers the smart antenna beams by maximizing the link layer performance criteria. By measuring and tracking the values of link layer metrics such as short-term receive throughput and/or short-term average transmission rates of received packets, the present invention can correctly steer the antenna beam toward the correct and desired direction (as shown by antenna pattern 204 in FIG. 2).

In order to select the optimal antenna beam, the present invention uses link layer metrics such as the short-term average throughput, short-term average transmission rate of packets successfully received, complement of packet error probabilities of the received packets (e.g., if P(E) represents the packet error probability, then 1−P(E) represents the complement), number of packets successfully received in the receiver chain, average throughput, average transmission rate of packets successfully transmitted, complement of packet error probabilities of the transmitted packets, and/or the number of packets successfully transmitted in the transmitter chain. All of these metrics are measured and collected during the measurement interval.

The beam steering criterion, whereby the steering of the smart antenna's plurality of antenna beams is to be optimized, is either pre-fixed by manual or configuration user input, or adaptively varied according to the measurement history of the link layer metric values. In the latter case in particular, the adaptive selection of the beam steering criterion enables the smart antenna system to select the best and most appropriate criterion in steering the antenna beam depending on the amount, type, direction, and distribution of data traffic as well as the user's particular preferences.

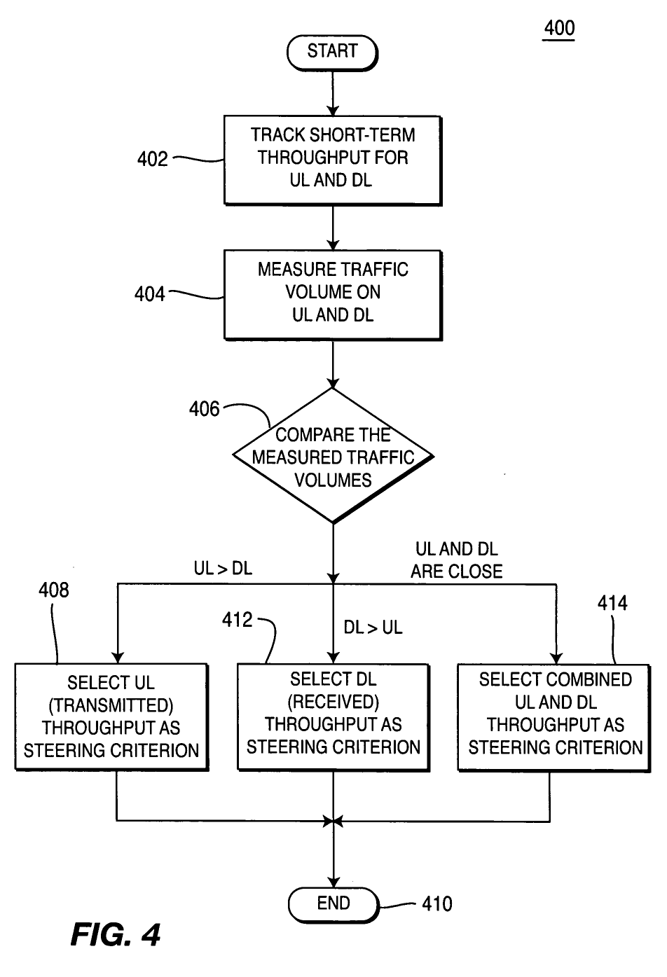

FIG. 4 shows a flowchart of a method 400 for selecting adaptive steering criterion. The method 400 begins by tracking the short-term throughput in the uplink (UL) and the downlink (DL) of the system (step 402). The traffic volume on both the UL and the DL are measured (step 404) and compared (step 406). If the UL traffic volume is greater than the DL traffic volume by a certain ratio, then the UL (transmitted) throughput is selected as the steering criterion (step 408) and the method terminates (step 410). If the DL traffic volume is greater than the UL traffic volume by a certain ratio (step 406), then the DL (received) throughput is selected as the steering criterion (step 412) and the method terminates (step 410). If the traffic volumes in the DL and UL directions are within a certain ratio range (step 406), then the combined DL and UL throughput are selected as the steering criterion (step 414) and the method terminates (step 410).

It should be noted that the method 400 can be used as part of step 302 in the method 300 for selecting the current beam steering criterion. The method 400 illustrates one example of selecting the beam steering criterion. Other criteria may be used, and a similar method would be performed to select the appropriate steering criterion. The important steps of the method are measuring the metrics, comparing the measured metrics, and selecting the steering criterion based on the results of the comparison. Such steering criterion adaptation enables a wireless data communication system with a smart antenna to effectively steer its antenna beams to optimize the most relevant traffic type, volume, or distribution.

The advantages of the present invention over prior art systems are at least two-fold. First, by employing the present invention, one could achieve better overall receiver performance measured in terms of metrics that are more meaningful to the user's experience, such as the data throughput that the user of the communication system can enjoy or the number of packets that can be received or sent.

Second, the present invention provides a flexible and versatile way to select the most appropriate metric and ways to combine the metrics for decisions over which antenna to use. A user of such a smart antenna system can customize the system performance according to the most appropriate performance criteria from a link layer perspective. If the user desires to maximize the receive throughput of the overall receiver system, the system measures the short-term receive throughput values for each of the switched-beam antenna directions, and then selects the best antenna according to the best-received throughput performance criteria.

In another case, where the user desires to maximize the throughput performance of the received chain and the transmit chain separately, the present invention provides a way to customize the selection of antenna beams based on the direction of the communication. In such a case, the antenna direction used for reception could be selected by the receive throughput criteria, and the antenna direction used for transmission could be selected by the transmit throughput criteria.

If, in yet another case, the overall objective is to maximize the combined throughput of the receiver and the transmitter, the present invention provides an easy way to maximize the combined metrics of short-term throughput on the receiver and the transmitter.

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A method for steering a smart antenna in a wireless communication system, comprising the steps of:
selecting a beam steering criterion;
switching the antenna to one of a plurality of measurement positions;
measuring link quality metrics at each measurement position;
optimizing the steering criterion based on the measured metrics;
steering the antenna to the position providing the optimized metrics.

2. The method according to claim 1, wherein the beam steering criterion includes an average of upload throughput and download throughput.

3. The method according to claim 1, wherein the beam steering criterion includes a combination of upload throughput and download throughput, with both the upload throughput and the download throughput being weighted.

4. The method according to claim 1, wherein the selecting step includes selecting the most recently used steering criterion.

5. The method according to claim 1, wherein the selecting step includes selecting a default steering criterion.

6. The method according to claim 1, wherein the optimizing step includes weighting the metrics from receive-side throughput and transmit-side throughput.

7. The method according to claim 1, further comprising the step of:
determining whether a scan condition is met, the determining step being performed prior to the switching step, whereby the switching step is performed only if the scan condition is met.

8. The method according to claim 7, wherein the scan condition includes a station acquiring an access point in the wireless communication system.

9. The method according to claim 1, further comprising the step of:
determining whether a rescan condition is met, the determining step being performed after the steering step, whereby the rotating step is repeated if the rescan condition is met.

10. The method according to claim 9, wherein the rescan condition includes a sudden change of received signal strength.

11. The method according to claim 9, wherein the rescan condition includes a sudden change of short term average throughput.

12. The method according to claim 1, further comprising the step of:
determining whether the steering criterion has changed, the determining step being performed after the steering step, whereby the switching step is repeated if the steering criterion has changed.

13. A method for selecting a beam steering criterion in a smart antenna system, comprising the steps of:
measuring performance metrics;
comparing the measured performance metrics; and
selecting the beam steering criterion based on the results of the comparison.

14. The method according to claim 13, wherein the measuring step includes measuring traffic volume on an uplink connection and a downlink connection;
the comparing step includes comparing the uplink traffic volume to the downlink traffic volume; and
the selecting step includes:
selecting the uplink throughput as the steering criterion if the uplink traffic volume is greater than the downlink traffic volume by a predetermined ratio;
selecting the downlink throughput as the steering criterion if the downlink traffic volume is greater than the uplink traffic volume by a predetermined ratio; and
selecting a combined uplink throughput and downlink throughput if the uplink traffic volume and the downlink traffic volume are within a predetermined ratio range.
